(19) United States
(12) Patent Application Publication
(10) Pub. No.: US 2010/0070339 A1
(43) Pub. Date: Mar. 18, 2010

(54) Associating an Entity with a Category

(75) Inventors: Choongsoon Bae, Albany, CA (US); Qing Wu, San Francisco, CA (US); Hyunyoung Choi, Mountain View, CA (US); Vivek Raghunathan, Fremont, CA (US)

Correspondence Address: FISH & RICHARDSON P.C., PO BOX 1022, MINNEAPOLIS, MN, 55440-1022, US

(73) Assignee: Google Inc.

(21) Appl. No.: 12/393,361

(22) Filed: Feb. 26, 2009

Related U.S. Application Data
(60) Provisional application No. 61/097,026, filed on Sep. 15, 2008.

(51) Int. Cl. G06Q 99/00; G06Q 30/00

(52) U.S. Cl. 705/10

(57) ABSTRACT

Among other disclosed subject matter, a computer-implemented method for associating an entity with a category includes determining a probability value for each of at least a subset of a plurality of categories, the probability value representing a likelihood that an identified entity belongs to the respective category and determined using information about the entity. The method includes identifying one of the plurality of categories for the entity using the probability value and a rule set for the plurality of categories that is based on training data.

### RELATED APPLICATIONS

This application claims priority under 35 USC §119(e) to U.S. Provisional Patent Application Ser. No. 61/097,026, filed on Sep. 15, 2008, the entire contents of which are hereby incorporated by reference.

### TECHNICAL FIELD

This document relates to information processing.

### BACKGROUND

Advertisers can run advertisement campaigns in any of multiple different platforms, including the Internet, television, radio, and billboards. Advertisements used in advertising campaigns can cover a range of products and services and can be directed toward specific audiences or more generally toward the greater population. For example, publishers operating websites can provide space to advertisers for presenting advertisements. Advertisements presented on a website are sometimes selected based on the content of the website.

### SUMMARY

The invention relates to associating an entity with a category.

In a first aspect, a computer-implemented method for associating an entity with a category includes determining a probability value for each of at least a subset of a plurality of categories, the probability value representing a likelihood that an identified entity belongs to the respective category and determined using information about the entity. The method includes recording one of the plurality of categories for the entity, the category identified using the probability value and a rule set for the plurality of categories.

Implementations can include any, all or none of the following features. The entity can be a content provider identified as enrolled in a program in which the content provider provides content to be published by at least one publisher, and the probability value can be determined using at least one keyword associated with the content provider and at least one financial value associated with the content provider. Determining the probability value can include mapping the at least one keyword at least to the subset of the plurality of categories; weighting at least the subset with the at least one financial value, wherein the financial value has been assigned to the corresponding keyword; and selecting a predetermined number of the categories as the subset. The rule set can be based on training data. The rule set can include a decision tree configured for selecting one of the plurality of categories by processing at least some of a plurality of decisions included in the decision tree. The method can further include generating the decision tree using the training data, wherein the training data comprises mappings of entities to one or more of the plurality of categories. Generating the decision tree can further include weighting the mappings using financial data regarding the entities. Weighting the mappings can further include oversampling at least a subset of the mappings based on the financial data corresponding to the subset of the mappings. Generating the decision tree can include selecting a structure for the decision tree; determining an extent of the decision tree, including how many of the plurality of decisions to be made before the one of the plurality of categories is selected; and determining threshold values to be used in the plurality of decisions. The decision tree can be generated iteratively. The content provider can be engaged in advertising and the plurality of categories can include verticals with which the content provider is to be matched. Generating the decision tree can further include identifying at least one of the verticals for which the determination of the probability values has a tendency to improperly assign the vertical to the content provider; and selecting at least one of the threshold values so that the tendency is reduced. The method can further include presenting information to a user based on the category having been identified for the entity. The information can indicate a seasonality associated with the category.

In a second aspect, a computer system includes a first classifier determining a probability value for each category of at least a subset of a plurality of categories, the probability value representing a likelihood that an identified entity belongs to the respective category and determined using information about the entity. The system includes a second classifier identifying one of the plurality of categories for the entity using the probability value and a rule set for the plurality of categories.

Implementations can include any, all or none of the following features. The rule set can be based on training data. The first classifier can take into account a financial value relating to the entity in determining the probability value. The rule set can include a decision tree configured for selecting one of the plurality of categories by processing at least some of a plurality of decisions included in the decision tree, and the computer system can further include a rule component generating the decision tree using the training data, wherein the training data comprises mappings of entities to one or more of the plurality of categories. The rule component can weight the mappings using financial data regarding the entities, including oversampling at least a subset of the mappings based on the financial data corresponding to the subset of the mappings. The system can further include a front end component presenting information to a user based on the second classifier having identified the category for the entity.

In a third aspect, a computer-implemented method for associating a content provider with a category includes identifying a content provider as enrolled in a program in which the content provider provides content to be published by at least one publisher. The method further includes receiving at least one keyword regarding the content provider and at least one financial value regarding the keyword. The method further includes receiving a plurality of categories, wherein the content provider is to be associated with at least one of the categories. The method further includes mapping the at least one keyword to a subset of the categories based on names of the categories. The method further includes associating each of at least the subset of the categories with a probability value representing a likelihood that the content provider should be associated with the respective category, the probability values weighted using the financial value. The method further includes receiving a rule set generated regarding the plurality of categories, the rule set configured for use in identifying one of the categories. The method further includes processing data regarding the content provider using the rule set, the data including at least: (i) the probability value for each of at least the subset of the categories (ii) financial data regarding the content provider; (iii) a geographic region with which the content provider is associated. The method further includes selecting one of the plurality of categories for the content provider based on the processing of the data. The method further includes associating the content provider with the selected category.

Implementations can provide any, all or none of the following advantages. Improved classification into categories can be provided. A probability-based classification can be revenue-weighted and can be made further specific by a rule-based classification previously trained using training data. Flexibility in classification can be increased.

The details of one or more embodiments are set forth in the accompanying drawings and the description below. Other features and advantages will be apparent from the description and drawings, and from the claims.

### DESCRIPTION OF DRAWINGS

FIG. 1 shows an example system that can identify a category for an entity.

FIG. 2 shows another example system that can identify a category for an entity.

FIG. 3 shows an example user interface that can present information based on a category having been identified for an entity.

FIG. 4 shows an example method that can be performed to identify a category for an entity.

FIG. 5 is a block diagram of a computing system that can be used in connection with computer-implemented methods described in this document.

Like reference symbols in the various drawings indicate like elements.

### DETAILED DESCRIPTION

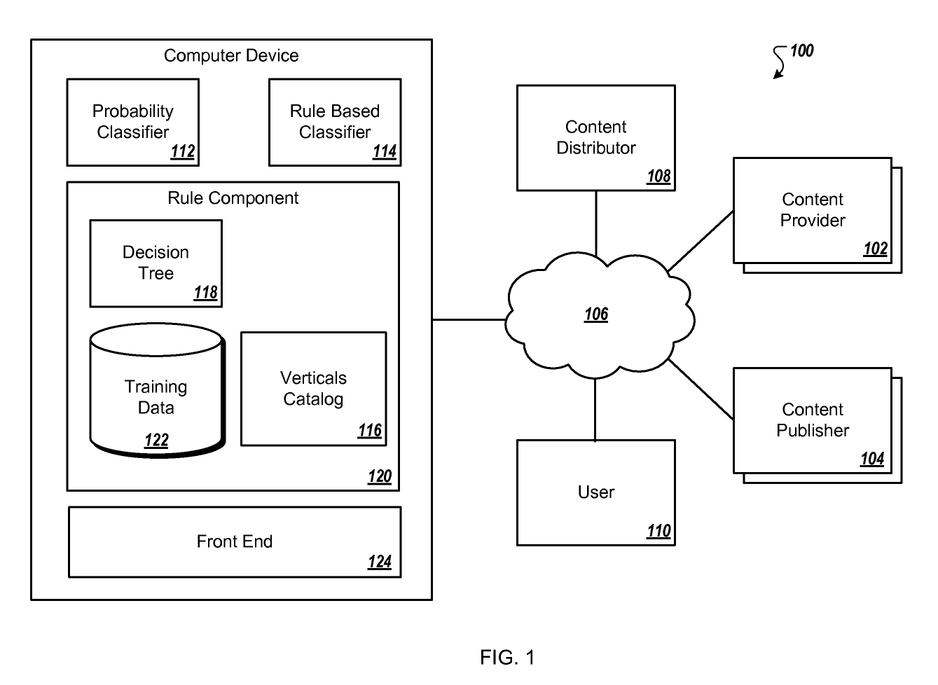

FIG. 1 shows an example system 100 that can identify a category for an entity. Multiple entities can operate in the system 100, for example, entities can be of the form of content providers such as advertisers and content publishers such as owners of web pages or other contents. In some implementations, the content providers can operate one or more content provider systems 102 and the content publishers can operate one or more content publisher systems 104. Any kind of computer device, electronic device or system can be included in the systems 102 and 104, such as a server computer or a personal computer. Components in the system 100 can communicate with each other using any kind of network 106, such as a local computer network or the Internet.

In some implementations, one or more entities in the system 100 can be involved in a transaction in which a content provider provides content to be published by at least one publisher. For example, content such as an advertisement can be distributed from the content provider system 102 over the network 106 for publication on behalf of one or more of the content publisher systems 104. In some implementations, the content can temporarily or permanently be held by a third party, such as a content distributor system 108 (e.g., an advertisement server) and can be distributed from the system 108 for publication. For example, when a user system 110 requests media content (e.g., a web page) from the publisher system 104, the content distributor system 108 can provide associated content (e.g., an advertisement) to the user system 110 for presentation in connection with the requested content. Below will be described examples in which one or more entities, such as a content provider and/or a content publisher in the system 100, can be classified using a catalog of categories. Such classification can be useful to anyone involved with the classified entity, for example a person who manages distribution of content between entities.

The system 100 can include one or more classifiers. In some implementations, the system 100 includes a probability classifier 112 and a rule based classifier 114. Names for these and other components are here used broadly, rather than narrowly; for example, the probability classifier 112 can use one or more rules in its operation, and the rule based classifier 114 can determine or use one or more probabilities in the classification process. The classifiers 112 and 114 can be implemented in any form, such as using software, hardware, firmware, or combinations thereof.

In some implementations, the classifiers 112 and 114 can be used in an effort to match a selected entity, such as the content provider operating the system 102, with one or more categories, such as verticals from a verticals catalog 116. A vertical can refer to one or more business classifications, such as the categorization terms sometimes used in marketing analysis to represent businesses and customers that trade in a common field (e.g., a consumer electronics vertical, or a cosmetics vertical). Other classifications can be used.

The probability classifier 112 can determine, for an entity such as a content provider, a probability value for at least one of the verticals in the catalog 116. The probability can represent a likelihood that the content provider belongs to the corresponding vertical. For example, the probability classifier can determine a probability that an entity “Example Company, Inc.” should be classified as belonging to a “mortgage” vertical. The probability can be determined using information about the entity. In some implementations, the probability classifier 112 can determine multiple probability values, such as a value corresponding to each of at least a subset of the verticals in the catalog 116.

The rule based classifier 114 can identify a category, such as one of the verticals in the catalog 116, for the entity. In some implementations, the rule based classifier 114 can use one or more probabilities determined by the probability classifier 112 and a rule set such as a decision tree 118. For example, the decision tree 118 can include a plurality of decisions and can be configured for selecting one of the plurality of verticals in the catalog 116 by processing at least some of the decisions. In some implementations, the system 100 can include a rule component 120 that generates the decision tree 118 or other rules based on training data 122. In some implementations, the training data 122 can include mappings of entities to respective ones of the categories, such as the verticals in the catalog 116.

A rule set such as the decision tree 118 can be generated in any of multiple ways. In some implementations, a model of the tree can be defined and the tree can then be generated based on the training data 122. For example, a structure of the tree can be selected, such as to define that the tree should include multiple levels of binary decisions. As another example, an extent of the tree can be defined (e.g., when should the decision tree end), such as how many of the plurality of decisions are to be made before the one of the plurality of categories is selected. In some implementations, one or more decisions in the tree 118 can use a threshold value. For example, a probability (e.g., one determined by the probability classifier 112) can be compared against the threshold value. One or more aspects of the decision tree 118 can be generated using any kind of iterative process. For example, a structure of the tree 118 can be chosen in an initial iteration and tested against representative data, such as the training data 122, and results of such testing can be used to generate another structure of the tree 118 in another iteration. As another example, a first set of threshold values can be determined in an initial iteration, and at least one of the values can be refined through a feedback process in one or more additional iterations.

The rule based classifier 114 can serve one or more purposes in the system 100. In some implementations, the probability classifier 112 can have a tendency to mis-classify entities in one or more regards. For example, the classifier 114 might frequently choose an “entertainment” vertical for entities that are in fact not involved, or involved only to a small degree, in the entertainment industry. Such characteristics in the probability determination can be artifacts of how the probability classifier 112 is configured and can depend on a number of factors, which can make it difficult or impractical to resolve the problem. In some implementations, the rule based classifier 114 can be used in combination with the probability classifier 112. For example, at least one of the threshold values in the rule set (e.g., the decision tree 118) used by the rule based classifier 114 can be selected so as to reduce or eliminate the tendency with regard to the category at issue.

At least one category (e.g., one of the verticals in the catalog 116) can be selected for a given entity, such as for the content provider operating the system 102. Such a selection can be used for one or more purposes, such as to output relevant information to a user. In some implementations, the system 100 can include a front end component 124 that can use one or more category selections. For example, the front end component 124 can present information relating to the selected category or categories as a way of characterizing the entity.

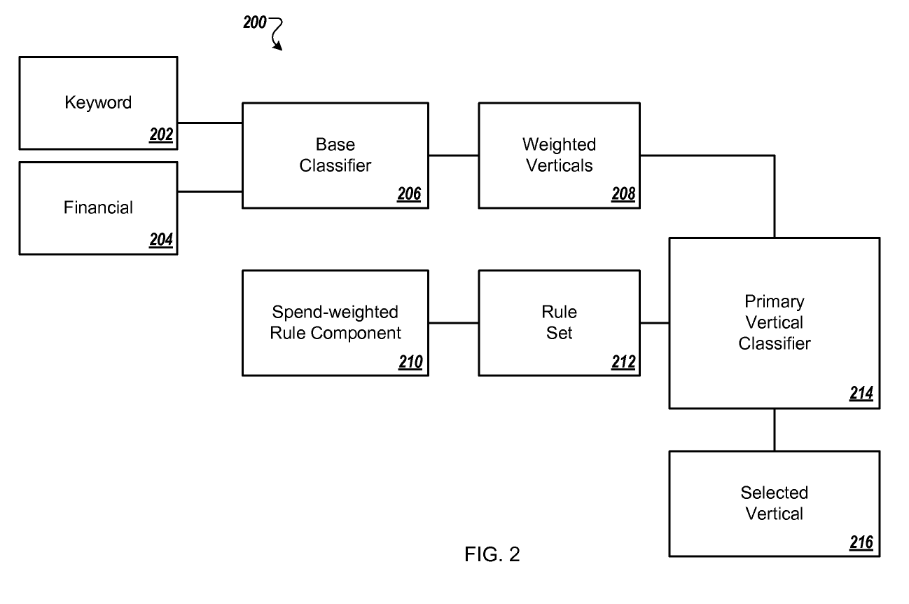

FIG. 2 shows another example system 200 that can identify a category for an entity. In the system 200, one or more information portions about an entity, such as keyword(s) 202 associated with a content provider, can be identified. In some implementations, the content provider can self-identify the keyword(s) as part of participating in a content distribution program. For example, an advertiser can register a bid on one or more keywords with the content distributor system 108 (FIG. 1) such that the advertiser's ad can be considered for publication in contexts that relate to the keyword(s). Financial information 204 about the entity can be identified. For example, this can include revenue data, such as information about how much an advertiser spends on a particular keyword.

The system 200 can include a base classifier 206. In some implementations, the base classifier can be configured to classify an entity, such as a content provider or a content distribution campaign, using a set of categories, such as the verticals catalog 116 (FIG. 1). In some implementations, the base classifier 206 can map the keywords 202 to some or all of the verticals and select a predetermined number of verticals. For example, three of the verticals can be chosen as being the most representative of the entity, such as by selecting those that have the largest weights.

The base classifier 206 can map multiple keywords for a particular entity to respective verticals. The respective verticals chosen for the keywords can be merged (e.g., their respective probabilities can be averaged) to form a single categorization for the entity. In some implementations, the verticals chosen for the entity can be weighted based on the financial data 204, such as based on the amounts spent on individual keywords. For example, verticals for keywords that account for a relatively large fraction of the content provider's or distribution campaign's spending can be given a relatively larger weight in computing the classification. In some implementations, the base classifier 206 can include the probability classifier 112 (FIG. 1). In some implementations, an output of the base classifier 206 can include one or more weighted verticals 208, such as at least one classifier term (e.g., the name of the vertical) associated with a weight (e.g., a number between zero and one).

The system 200 can include a spend-weighted rule component 210. In some implementations, the component 210 can provide a policy for defining a primary one among several categories, such as among three revenue weighted verticals. For example, the component 210 can run as an offline program with regard to other components in the system 200, such as in form of a program in the MATLAB environment developed by The Mathworks company.

The spend-weighted rule component 210 can be configured for a multi-class classification on a multidimensional feature space. In some implementations, n dimensions of features can be used for mapping to any of m dimensions. For example, the verticals catalog 116 can include 30 verticals. As another example, additional features can be identified including, but not limited to, quarterly spend of the entity, total spend of the entity, number of keywords for the entity, and billing country of the entity. Thus, a 34-dimentional feature space (i.e, n=34) can be used for a classification into any of 30 dimensions (i.e, m=30). In some implementations, one or more of the feature dimensions, such as the entity country, can be categorical. For example, a predetermined number of top countries (e.g., nine countries) can be assigned one class each, and remaining countries can be grouped in a common class. In some implementations, one or more of the feature dimensions can be a discrete or a continuous variable. For example, a key word count can be a discrete variable and/or total spend can be a continuous variable.

In some implementations, the spend-weighted rule component 210 can include the rule based classifier (FIG. 1). For example, the component 210 can use some or all of the training data 122 to define an appropriate policy. In some implementations, the spend-weighted rule component 210 can be triggered when a new or modified set of training data becomes available, such as when human classifiers have mapped one or more entities to the verticals catalog 116.

The spend-weighted rule component 210 can output a rule set 212 that can be used in selecting the category for the entity. In some implementations, the rule set can include a decision tree. For example, the component 210 can split and grow a decision tree to optimize the determined probability that the given entity is a member of a particular category. As another example, the training data 122 (FIG. 1) can be used to prune the decision tree, such as to avoid overfitting.

In some implementations, a feature such as “Classification and Regression Trees” (CART) can be used. In such implementations, the spend-weighted rule component 210 can include or be based on a CART classifier. For example, CART models can be constructed with a customized pruning procedure (e.g., a stopping rule). As another example, error estimations of the CART model can be calculated using 10-fold cross validation.

In some implementations, the rule set 212 includes a classification decision tree of one-dimensional rules for mapping a set of (e.g., three) revenue weighted verticals into one vertical for the entity. For example, this can provide the benefit of greater generalization capability in the system 200, such as to allow pruning of “bad verticals” and/or other systemic errors from the base classifier 206.

In generating the rule set 212, financial data can be taken into account. In some implementations, data can be replicated when a CART model is constructed, such as to proportionate the amount of replication with the spent amount(s). For example, data corresponding to a relatively high total and/or quarterly spend level can be oversampled. As another example, data corresponding to a relatively low total and/or quarterly spend level can be undersampled. In some implementations, additional training data points based on revenue can tend to bias the final output (e.g., the selection of one or more categories) to high-spending entities (e.g., content providers) and improve accuracy regarding these entities.

An example of the rule set 212, here a decision tree, is presented below in Appendix I.

The system 100 can include a primary vertical classifier 214. In some implementations, the classifier can statically map a set of revenue-weighted categories (e.g., the weighted verticals 208) into a single primary vertical for the entity. For example, the classifier 214 can use the rule set 212 (such as by loading a CART classification tree generated by the component 210) to select one of the weighted categories from the base classifier 206.

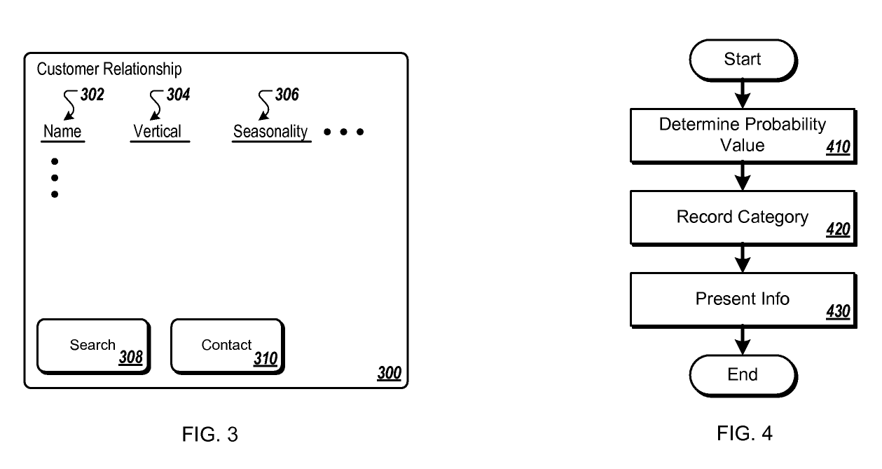

FIG. 3 shows an example user interface 300 that can present information based on a category having been identified for an entity. In some implementations, the front end component 124 (FIG. 1) can generate the user interface 300, such as to an actor in the system 100. In some implementations, the user interface 300 can be used to manage customer relationships, such as to monitor and/or track participants in a content distribution program, such as an advertising campaign. The user interface 300 can include a “name” area 302 where an identifier for one or more entities can be presented, such as the name of an advertiser and/or another content provider. The user interface 300 can include a “vertical” area 304 where a category identified for the entity can be indicated, such as a vertical from the catalog 116. The user interface 300 can include one or more areas presenting information relating to the category assigned to the entity, such as a “seasonality” area 306. For example, companies engaged in a particular vertical (e.g., tax preparation consultants or flower retailers) can have seasonally occurring fluctuations in their business and/or other activities. In some implementations, such a seasonality (e.g., an information that “this entity's business might peak around Valentine's Day”) can be output to a user. In some implementations, the related information (e.g., the seasonality area 306) can be output without explicitly indicating the selected vertical. The user interface 300 can include a “search” control 308 by which the user can search for entities using one or more criteria, and results of such searches can be presented by populating information in one or more of the areas 302-306. The user interface 300 can include a “contact” control 310 by which the user can initiate a contact with one or more entities, such as by email or telephone. For example, upon seeing information in the seasonality area 306, a user such as a sales representative might contact the entity to make sure its needs are met regarding the busy season.

FIG. 4 shows an example method 400 that can be performed to identify a category for an entity. The method 400 can be performed by a processor executing instructions stored in a computer-readable medium, for example in the systems 100 and/or 200. In some implementations, one or more of the steps can be performed in another order; as another example, more or fewer steps can be performed.

Step 410 includes determining a probability value for each of at least a subset of a plurality of categories. The probability value can represent a likelihood that an identified entity belongs to the respective category and can be determined using information about the entity. For example, the probability classifier 112 and/or the base classifier can generate the weighted verticals 208 for a particular entity such as a content provider or a content publisher. The subset can include one or more categories.

Step 420 includes recording one of the plurality of categories for the entity, the category identified using the probability value and a rule set for the plurality of categories that is based on, for example, training data. For example, the rule based classifier 114 and/or the primary vertical classifier 214 can select one vertical from the catalog 116 to be associated with the particular entity.

Step 430 includes presenting information based on the identification of a category for the entity. For example, the front end component 124 can generate the user interface 300 that can present the seasonality area 306

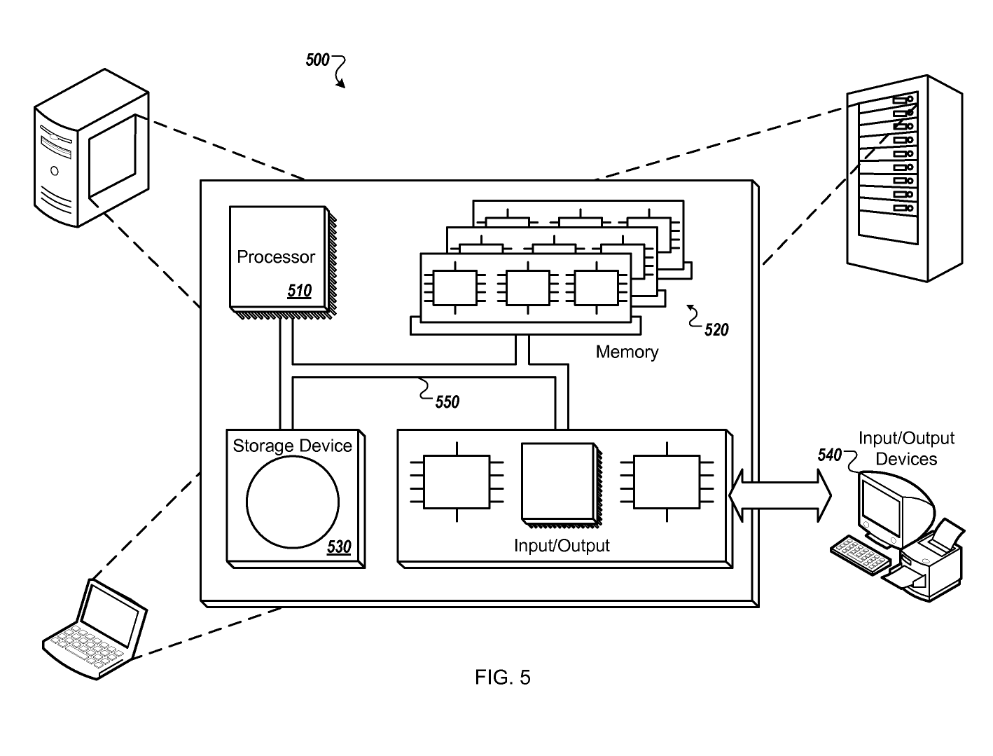

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

### Appendix I

### CART Model Description and Output

### Independent Variables

x1: Country(e.g., by country code)
x2: Keyword Count
x3: Total Spend (USD)
x4: Quarterly Spend (USD)
x5˜x34: Revenue weights for verticals ordered from smallest to largest (e.g., the output of the classifier 112 or 206)

| | Id | | | | | | | | | |
|---|---|---|---|---|---|---|---|---|---|---|
| | x5 | x6 | x7 | x8 | x9 | x10 | x11 | x12 | x13 | x14 |
| Vertical | 2 | 3 | 4 | 5 | 7 | 8 | 11 | 12 | 13 | 14 |
| | Id | | | | | | | | | |
| | x15 | x16 | x17 | x18 | x19 | x20 | x21 | x22 | x23 | x24 |
| Vertical | 15 | 16 | 18 | 19 | 20 | 29 | 44 | 45 | 47 | 52 |
| | Id | | | | | | | | | |
| | x25 | x26 | x27 | x28 | x29 | x30 | x31 | x32 | x33 | x34 |
| Vertical | 66 | 67 | 71 | 174 | 285 | 299 | 397 | 439 | 533 | 570 |

### CART Output

### Decision Tree for Classification

1 if x26<0.156561 then node 2 else node 3
2 if x9<0.370092 then node 4 else node 5
3 if x26<0.657022 then node 6 else node 7
4 if x17<0.495845 then node 8 else node 9
5 if x9<0.823663 then node 10 else node 11
6 if x15<0.0685697 then node 12 else node 13
7 if x21<0.0848807 then node 14 else node 15
8 if x8<0.521697 then node 16 else node 17
9 if x17<0.736217 then node 18 else node 19
10 if x23<0.498586 then node 20 else node 21
11 class=7
12 if x20<0.257736 then node 22 else node 23
13 if x20<00258419 then node 24 else node 25
14 class=67
15 if x2<7168.5 then node 26 else node 27
16 if x24<0.354713 then node 28 else node 29
17 if x8<0.716763 then node 30 else node 31
18 if x2<80663 then node 32 else node 33
19 if x17<0.925121 then node 34 else node 35
20 if x18<0.213272 then node 36 else node 37
21 class=47
22 if x12<0.335248 then node 38 else node 39
23 if x1 in {1 3 4 6} then node 40 else node 41
24 if x29<0.230442 then node 42 else node 43
25 class=29
26 class=44
27 class=52
28 if x1 1<0.331887 then node 44 else node 45
29 class=52
30 if x2<7057.5 then node 46 else node 47
31 class=5
32 if x7<0.0829784 then node 48 else node 49
33 if x1=1 then node 50 else node 51
34 if x2<77348 then node 52 else node 53
35 class=18
36 if x20<0.371657 then node 54 else node 55
37 if x3<3.85033e+06 then node 56 else node 57
38 if x19<0.330368 then node 58 else node 59
39 class=12
40 class=29
41 class=67
42 class=67
43 class=285
44 if x23<0.57222 then node 60 else node 61
45 if x7<0.114347 then node 62 else node 63
46 if x13<0.330393 then node 64 else node 65
47 if x7<0.255785 then node 66 else node 67
48 if x1 in {1 2 3 7 8 10} then node 68 else node 69
49 class=4
50 class=11
51 class=285
52 class=18
53 class=20
54 class=7
55 class=29
56 class=7
57 class=19
58 if x21<0.203319 then node 70 else node 71
59 class=20
60 if x3<4.08266e+07 then node 72 else node 73
61 if x23<0.730036 then node 74 else node 75
62 if x 1<0.537014 then node 76 else node 77
63 if x1 in {1 2 8 10} then node 78 else node 79
64 if x24<0.10869 then node 80 else node 81
65 if x2<1310 then node 82 else node 83
66 if x1 in {1 2 5 7} then node 84 else node 85
67 class=4
68 class=18
69 if x2<39894 then node 86 else node 87
70 if x13<0.193039 then node 88 else node 89
71 class=44
72 if x22<0.442255 then node 90 else node 91
73 class=5
74 if x12<0. 179846 then node 92 else node 93
75 class=47
76 if x27<0. 189842 then node 94 else node 95
77 class=11
78 class=4
79 class=11
80 class=5
81 if x1 in {1 3 6 8 10} then node 96 else node 97
82 class=13
83 class=5
84 if x32<0.117921 then node 98 else node 99
85 class=5
86 if x21<0.268462 then node 100 else node 101
87 class=52
88 if x17<0.209712 then node 102 else node 103
89 class=13
90 if x7<0.35475 then node 104 else node 105
91 if x22<0.711517 then node 106 else node 107
92 if x2<10.5 then node 108 else node 109
93 class=12
94 if x4<368742 then node 110 else node 111
95 class=71
96 class=5
97 class=52
98 class=19
99 class=18
100 class=18
101 class=44
102 if x23<0.262412 then node 112 else node 113
103 class=18
104 if x18<0.513483 then node 114 else node 115
105 class=4
106 if x21<0.210351 then node 116 else node 117
107 class=45
108 class=18
109 class=47
110 if x12<0.433287 then node 118 else node 119
111 class=11
112 if x7<0.569093 then node 120 else node 121
113 class=47
114 if x20<0.473106 then node 122 else node 123
115 if x22<0.158422 then node 124 else node 125
116 if x6<0.0777122 then node 126 else node 127
117 if x21<0.470751 then node 128 else node 129
118 if x3<1.47723e+06 then node 130 else node 131
119 if x3<5.20398e+06 then node 132 else node 133
120 if x14<0.396659 then node 134 else node 135
121 class=4
122 if x12<0.470398 then node 136 else node 137
123 if x17<0.306859 then node 138 else node 139
124 if x18<0.824979 then node 140 else node 141
125 class=19
126 class=45
127 if x3<1.93593e+06 then node 142 else node 143
128 if x3<1.44848e+06 then node 144 else node 145
129 class=45
130 class=11
131 class=8
132 if x1 in {1 4 5 6 8} then node 146 else node 147
133 class=11
134 if x 1<0.09162 then node 148 else node 149
135 class=14
136 if x21<0.385516 then node 150 else node 151
137 if x12<0.821368 then node 152 else node 153
138 class=29
139 class=18
140 if x4<104730 then node 154 else node 155
141 if x27<0.019163 then node 156 else node 157
142 class=2
143 class=29
144 if x4<2953.45 then node 158 else node 159
145 class=44
146 class=12
147 if x3<361231 then node 160 else node 161
148 if x9<0.384375 then node 162 else node 163
149 class=11
150 if x14<0.452462 then node 164 else node 165
151 class=44
152 if x7<0.159118 then node 166 else node 167
153 class=12
154 if x3<1.58799e+06 then node 168 else node 169
155 class=19
156 class=19
157 class=13
158 class=44
159 class=45
160 if x2<653 then node 170 else node 171
161 class=11
162 if x24<0.262085 then node 172 else node 173
163 class=7
164 if x13<0.32757 then node 174 else node 175
165 if x30<0.28577 then node 176 else node 177
166 if x 18<0.247799 then node 178 else node 179
167 class=4
168 if x 13<0.00967496 then node 180 else node 181
169 class=18
170 class=11
171 class=12
172 if x8<0.281417 then node 182 else node 183
173 class=52
174 if x30<0.258444 then node 184 else node 185
175 if x 13<0.779286 then node 186 else node 187
176 class=14
177 class=299
178 if x11<0.0620939 then node 188 else node 189
179 class=19
180 if x19<0.123657 then node 190 else node 191
181 class=13
182 class=67
183 class=5
184 if x33<0.118834 then node 192 else node 193
185 if x1 in {1 2 3 5 6 7 8} then node 194 else node 195
186 if x33<0.326535 then node 196 else node 197
187 class=13
188 if x17<0.114527 then node 198 else node 199
189 if x12<0.640493 then node 200 else node 201
190 class=19
191 class=20
192 if x10<0.508978 then node 202 else node 203
193 if x33<0.544036 then node 204 else node 205
194 if x13<0.0837794 then node 206 else node 207
195 if x30<0.620821 then node 208 else node 209
196 if x32<0.085737 then node 210 else node 211
197 class=533
198 class=12
199 if x4<34722.4 then node 212 else node 213
200 class=11
201 class=12
202 if x32<0.33374 then node 214 else node 215
203 class=8
204 if x8<0.00714825 then node 216 else node 217
205 class=533
206 if x 15<0.248854 then node 218 else node 219
207 if x3<709455 then node 220 else node 221
208 class=2
209 if x30<0.818431 then node 222 else node 223
210 class=13
211 class=439
212 class=18
213 class=12
214 if x27<0.445613 then node 224 else node 225
215 if x30<0.0232432 then node 226 else node 227
216 class=533
217 class=5
218 class=299
219 if x1 in {1 2 3 5 7 8} then node 228 else node 229
220 class=299
221 class=13
222 class=299
223 class=2
224 if x19<0.0842646 then node 230 else node 231
225 class=71
226 class=439
227 class=2
228 class=299
229 class=52
230 if x15<0.792343 then node 232 else node 233
231 if x3<1.43634e+06 then node 234 else node 235
232 if x34<0.432739 then node 236 else node 237
233 if x20<0.00676158 then node 238 else node 239
234 if x4<142308 then node 240 else node 241
235 if x3<2.28536e+06 then node 242 else node 243
236 if x6<0.343384 then node 244 else node 245
237 class=570
238 if x26<2.31392e−13 then node 246 else node 247
239 class=29
240 class=20
241 class=18
242 if x4<177429 then node 248 else node 249
243 class=7
244 if x25<0.735451 then node 250 else node 251
245 if x14<0.037943 then node 252 else node 253
246 if x4<44870.6 then node 254 else node 255
247 if x1 in {1 3 4 7 10} then node 256 else node 257
248 class=47
249 if x1=1 then node 258 else node 259
250 if x29<0.376623 then node 260 else node 261
251 class=66
252 if x6<0.904535 then node 262 else node 263
253 if x2<782 then node 264 else node 265
254 if x17<0.0111276 then node 266 else node 267
255 class=15
256 class=67
257 class=15
258 class=45
259 class=18
260 if x9<0.127178 then node 268 else node 269
261 if x29<0.720004 then node 270 else node 271
262 if x8<0.0786027 then node 272 else node 273
263 if x4<224146 then node 274 else node 275
264 class=3
265 class=2
266 class=15
267 class=2
268 if x20<0.107796 then node 276 else node 277
269 if x3<2.68169e+06 then node 278 else node 279
270 if x14<0.0382579 then node 280 else node 281
271 class=285
272 if x30<00283009 then node 282 else node 283
273 if x24<0.0668307 then node 284 else node 285
274 if x19<0.0325977 then node 286 else node 287
275 class=2
276 if x16<0.487338 then node 288 else node 289
277 if x15<0.486436 then node 290 else node 291
278 if x9<0.366797 then node 292 else node 293
279 class=13
280 if x11<0.0434011 then node 294 else node 295
281 class=14
282 if x3<1.79108e+06 then node 296 else node 297
283 class=2
284 if x1 in {1 2 4 5 7} then node 298 else node 299
285 class=52
286 class=3
287 class=52
288 if x17<0.188053 then node 300 else node 301
289 class=16
290 if x23<0.249635 then node 302 else node 303
291 class=29
292 class=7
293 class=45
294 class=285
295 class=11
296 if x25<0.0849167 then node 304 else node 305
297 if x6<0.816804 then node 306 else node 307
298 class=5
299 class=3
300 if x3<5.75773e+06 then node 308 else node 309
301 if x23<0.367225 then node 310 else node 311
302 if x15<0.0297698 then node 312 else node 313
303 if x1=4 then node 314 else node 315
304 if x24<0.0109364 then node 316 else node 317
305 class=66
306 class=3
307 class=2
308 if x18<0.358197 then node 318 else node 319
309 class=45
310 if x14<0.30828 then node 320 else node 321
311 if x1 in {1 2 4 10} then node 322 else node 323
312 class=4
313 if x1 in {1 2 3 4 6 8} then node 324 else node 325
314 class=47
315 class=15
316 if x7<0.0529852 then node 326 else node 327
317 class=52
318 if x8<0.250055 then node 328 else node 329
319 class=19
320 if x34<0.299071 then node 330 else node 331
321 class=14
322 class=47
323 class=14
324 if x1 in {1 8} then node 332 else node 333
325 class=533
326 if x18<0.346103 then node 334 else node 335
327 class=4
328 if x12<0.00523925 then node 336 else node 337
329 if x3<1.54296e+06 then node 338 else node 339
330 class=18
331 class=570
332 class=29
333 class=19
334 if x34<0.24078 then node 340 else node 341
335 class=19
336 if x24<0.0618855 then node 342 else node 343
337 if x7<0.269018 then node 344 else node 345
338 if x1 in {1 5 6 10} then node 346 else node 347
339 class=18
340 if x6<0.744853 then node 348 else node 349
341 class=570
342 if x25<0.725171 then node 350 else node 351
343 class=52
344 if x11<0.145951 then node 352 else node 353
345 class=4
346 class=5
347 if x7<0.074593 then node 354 else node 355
348 if x1 in {1 2 3 7 8 9 10} then node 356 else node 357
349 class=3
350 if x3<312875 then node 358 else node 359
351 class=7
352 if x4<40808.4 then node 360 else node 361
353 class=11
354 if x1 in {23 4 8} then node 362 else node 363
355 class=4
356 if x3<602261 then node 364 else node 365
357 class=16
358 if x28<0.99751 then node 366 else node 367
359 if x10<0.204898 then node 368 else node 369
360 class=12
361 class=15
362 if x3<579398 then node 370 else node 371
363 class=13
364 if x1 in {1 2 3 8 9} then node 372 else node 373
365 class=533
366 if x25<0.389004 then node 374 else node 375
367 class=174
368 class=15
369 class=8
370 if x2<95 then node 376 else node 377
371 class=67
372 if x3<56290.8 then node 378 else node 379
373 class=2
374 if x21<0.073466 then node 380 else node 381
375 class=66
376 class=12
377 class=5
378 class=3
379 class=18
380 if x15<0.329107 then node 382 else node 383
381 class=44
382 class=14
383 class=15

What is claimed is:

1. A computer-implemented method for associating an entity with a category, the method comprising:
determining a probability value for each of at least a subset of a plurality of categories, the probability value representing a likelihood that an identified entity belongs to the respective category and determined using information about the entity; and
recording one of the plurality of categories for the entity, the category identified using the probability value and a rule set for the plurality of categories.

2. The computer-implemented method of claim 1, wherein the entity is a content provider identified as enrolled in a program in which the content provider provides content to be published by at least one publisher, and wherein the probability value is determined using at least one keyword associated with the content provider and at least one financial value associated with the content provider.

3. The computer-implemented method of claim 2, wherein determining the probability value comprises:
mapping the at least one keyword at least to the subset of the plurality of categories;
weighting at least the subset with the at least one financial value, wherein the financial value has been assigned to the corresponding keyword; and
selecting a predetermined number of the categories as the subset.

4. The computer-implemented method of claim 1, wherein the rule set is based on training data.

5. The computer-implemented method of claim 4, wherein the rule set includes a decision tree configured for selecting one of the plurality of categories by processing at least some of a plurality of decisions included in the decision tree.

6. The computer-implemented method of claim 5, further comprising:
generating the decision tree using the training data, wherein the training data comprises mappings of entities to one or more of the plurality of categories.

7. The computer-implemented method of claim 6, wherein generating the decision tree further comprises:
weighting the mappings using financial data regarding the entities.

8. The computer-implemented method of claim 7, wherein weighting the mappings further comprises:
oversampling at least a subset of the mappings based on the financial data corresponding to the subset of the mappings.

9. The computer-implemented method of claim 5, wherein generating the decision tree comprises:
selecting a structure for the decision tree;
determining an extent of the decision tree, including how many of the plurality of decisions to be made before the one of the plurality of categories is selected; and
determining threshold values to be used in the plurality of decisions.

10. The computer-implemented method of claim 8, wherein the decision tree is generated iteratively.

11. The computer-implemented method of claim 6, wherein the content provider is engaged in advertising and wherein the plurality of categories include verticals with which the content provider is to be matched.

12. The computer-implemented method of claim 10, wherein generating the decision tree further comprises:
identifying at least one of the verticals for which the determination of the probability values has a tendency to improperly assign the vertical to the content provider; and
selecting at least one of the threshold values so that the tendency is reduced.

13. The computer-implemented method of claim 1, further comprising:
presenting information to a user based on the category having been identified for the entity.

14. The computer-implemented method of claim 12, wherein the information indicates a seasonality associated with the category.

15. A computer system comprising:
a first classifier determining a probability value for each category of at least a subset of a plurality of categories, the probability value representing a likelihood that an identified entity belongs to the respective category and determined using information about the entity; and
a second classifier identifying one of the plurality of categories for the entity using the probability value and a rule set for the plurality of categories.

16. The computer system of claim 14, wherein the rule set is based on training data.

17. The computer system of claim 16, wherein the rule set includes a decision tree configured for selecting one of the plurality of categories by processing at least some of a plurality of decisions included in the decision tree, the computer system further comprising:
a rule component generating the decision tree using the training data, wherein the training data comprises mappings of entities to one or more of the plurality of categories.

18. The computer system of claim 17, wherein the rule component weights the mappings using financial data regarding the entities, including oversampling at least a subset of the mappings based on the financial data corresponding to the subset of the mappings.

19. The computer system of claim 14, further comprising:
a front end component presenting information to a user based on the second classifier having identified the category for the entity.

20. A computer-implemented method for associating a content provider with a category, the method comprising:
identifying a content provider as enrolled in a program in which the content provider provides content to be published by at least one publisher;
receiving at least one keyword regarding the content provider and at least one financial value regarding the keyword;
receiving a plurality of categories, wherein the content provider is to be associated with at least one of the categories;
mapping the at least one keyword to a subset of the categories based on names of the categories;
associating each of at least the subset of the categories with a probability value representing a likelihood that the content provider should be associated with the respective category, the probability values weighted using the financial value;
receiving a rule set generated regarding the plurality of categories, the rule set configured for use in identifying one of the categories;
processing data regarding the content provider using the rule set, the data including at least: (i) the probability value for each of at least the subset of the categories (ii) financial data regarding the content provider; (iii) a geographic region with which the content provider is associated;
selecting one of the plurality of categories for the content provider based on the processing of the data; and
associating the content provider with the selected category.
